(19) United States
(12) Patent Application Publication
(10) Pub. No.: US 2008/0041987 A1
(43) Pub. Date: Feb. 21, 2008

(54) Top-lifting paper shredder

(75) Inventor: Tie Chun Wang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/797,674

(22) Filed: May 7, 2007

(30) Foreign Application Priority Data
May 22, 2006 (CN) 200620113878.7

(51) Int. Cl. B02C 23/00

(52) U.S. Cl. 241/100

(57) ABSTRACT

A top-lifting paper shredder, including rectangular projections each projecting outwards from an appropriate position of opposing sides of the paper shredder; V-shaped notches formed to the wastebasket and composing a lower slant and a wall face at locations corresponding to the rectangular projections. When the paper shredder is placed above the wastebasket, the rectangular projections projecting from the opposing sides of the paper shredder abut against the notches of the wastebasket. Upon lifting up a grip provided to a front end of the paper shredder, the rectangular projections would flip upwards within the notches of the wastebasket, causing an upper edge of the rectangular projections to abut against the wall faces of the notches to keep the paper shredder at an upright position and to allow the user's palm to press the shreds for increasing the capacity of the wastebasket

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of Invention

This invention relates to a paper shredder, particular to one where there is no need to remove wastebasket from the paper shredder when the wastebasket is filled up, but allowing the user to lift the paper shredder to an upright position and then to press the shreds downwards by his palm so as to increase capacity of the wastebasket.

2. Background

It is widely known that paper shredders for shredding incorporate plural cutting blades and spacers passing through rotary shafts that are driven to rotate towards each other by a motor and gear box so as to shred paper passing through the rotary shafts into strips by shear forces. Shredders can be classed into two types, the stripe-cut shredders and crosscut shredders, according to the machine cutting style. The former shredders arrange cutting blades to the rotating cutter shafts in a manner for cutting the paper in a longitudinal direction to form strips. The later shredders include blades that include more than one cutting edge part, and each cutter is disposed helically along the rotary cutter shaft for first cutting paper along a horizontal direction into strips and then cutting paper along a longitudinal direction into shreds of 4 mm by 40 mm.

Regardless of being stripe-cut or crosscut shredders, a basket or bin commonly accompanies the shredders at sales. Upon filling of the basket or bin, the user needs to empty the shreds in the basket or bin to prevent the shreds from entering the gaps between the cutting blades or obstructing normal operation of the paper shredders. Experiences show that, the fragmented paper strips or shreds can easily and freely fall into the basket or bin through the paper drop opening of the paper shredders. Since the light weighted paper strips or shreds are accumulated in a random manner, the spaces between the paper strips or shreds are relatively large so as to easily fill up the basket or bin as viewed by the user. However, as stated above, since the light weighted paper strips or shreds are accumulated in a random manner, the spaces between the paper strips or shreds are relatively large, when the user removes the paper shredders from the basket or bin and then manually presses the paper strips or shreds in the basket or bin, the user will realize that the seemingly filled basket or bin, in fact, as more than half of empty space after pressing. Thus, if the paper shredders are provided with a paper pressing device operating like manual pressing, the capacity of the basket or bin can be increased significantly, so as to reduce the frequency of emptying the basket or bin.

Furthermore, experiences show that when the wastebasket has been filled up, and one needs to dump shreds into garbage bags, once removing the paper shredder from the wastebasket, shreds caught between gaps of the cutting blades frequently fall over the floor such that the user need to clean up the mess by hand, which is quite inconvenient.

FIGS. 1 and 2 illustrate a paper shredder disclosed in US 2005/0072869A1, where the shredder includes a shredder cover and a shred container. The shredder includes a shredder for shredding paper, the shredder cover having an upper face formed with a paper entrance and a lower face formed with a paper exit, wherein the shredder cover further has two opposite sides interconnecting said upper and lower faces and two pivot members provided respectively on said opposite sides. The shredder cover includes a handle at one side of said pivot members which are symmetrically opposite to each other, capable of being used as the point of force application for turning and opening said shredder cover, whereby said shredder cover can be rotated about the axes of said pivot members. The shred container is disposed below said shredder cover to receive shreds from said shredder. The shred container has an open end which includes two opposite edges respectively provided with pivot seats, said pivot members being mounted respectively on said pivot seats so that said shredder cover is mounted on said shred container and said shredder cover is turnable about the axes of said pivot members. Each of said pivot seats is in the form of a curved wall that is indented downwardly from said open end of said shred container. Each of the pivot members is generally cylindrical in cross-section. The shredder cover further comprises a pair of rotation limiting members, each of which projects radially and outwardly from a circumferential portion of a respective one of said pivot members, and each of which is adapted to abut against one of two opposite edges of a respective one of said pivot seats so as to restrict angular rotation of said shredder cover relative to said shred container when said shredder cover is turned to said open position, and to prevent the separation of the paper shredder cover from the shred container.

However, the above prior art adopts a complicated structure to allow the paper shredder cover to pivot bout to pivot members. In particular, curved wall that is indented downwardly from said open end of said shred container must be formed to each of the pivot seats, and the pair of rotation limiting members, each of which projects radially and outwardly from a circumferential portion of a respective one of said pivot members, and each of which is adapted to abut against one of two opposite edges of a respective one of said pivot seats so as to allow reciprocal angular rotation of said shredder cover relative to said shred container, all require precision molds of a higher cost. Accordingly, the manufacturing cost and the assembling cost of such paper shredder can hardly been reduced thereby diminishing its market compositeness.

### SUMMARY OF INVENTION

It is a primary object of this invention to provide a paper shredder, where there is no need to remove wastebasket from the paper shredder when the wastebasket is filled up, but allowing the user to lift the paper shredder to an upright position and then to press the shreds downwards by his palm so as to increase capacity of the wastebasket.

It is another object of this invention to provide a top-lifting paper shredder, where when the wastebasket has been filled up, and one needs to dump shreds into garbage bags, the user may first clean up shreds caught between the paper cutters and cause them to fall into the wastebasket therebeneath, so as to overcome the problem where once removing the paper shredder from the wastebasket, shreds caught between gaps of the cutting blades frequently fall over the floor such that the user need to clean up the mess by hand, which is quite inconvenient

To achieve the above objects, this invention provides a top-lifting paper shredder, including rectangular projections each projecting outwards from an appropriate position of opposing sides of the paper shredder; V-shaped notches formed to the wastebasket and composing a lower slant and a wall face at locations corresponding to the rectangular projections. When the paper shredder is placed above the wastebasket, the rectangular projections projecting from the opposing sides of the paper shredder abut against the notches of the wastebasket. Upon lifting up a grip provided to a front end of the paper shredder, the rectangular projections would flip upwards within the notches of the wastebasket, causing an upper edge of the rectangular projections to abut against the wall faces of the notches to keep the paper shredder at an upright position and to allow the user's palm to press the shreds for increasing the capacity of the wastebasket.

### BRIEF DESCRIPTION OF THE DRAWINGS

These and other modifications and advantages will become even more apparent from the following detained description of a preferred embodiment of the invention and from the drawings in which:

FIG. 1 is an exploded perspective view showing the paper shredder of US2005/0072869A1;

FIG. 2 is a schematic drawing illustrating the operations of the paper shredder of US2005/0072869A1;

FIG. 3 is an exploded, perspective view of the top-lifting paper shredder of this invention;

FIG. 4 is a schematic drawing illustrating the top-lifting paper shredder of this invention before lifting; and

FIG. 5 is a schematic drawing illustrating the top-lifting paper shredder of this invention after lifting.

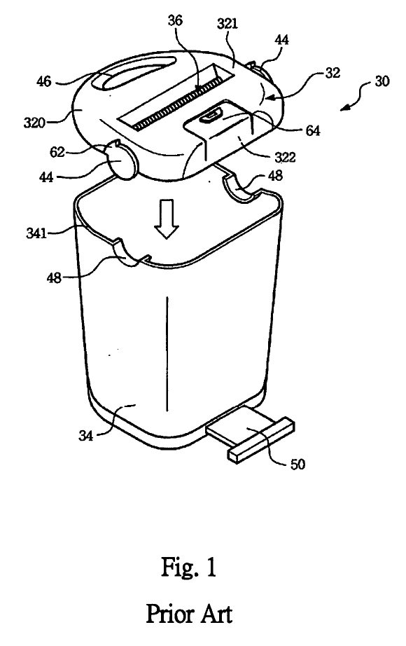

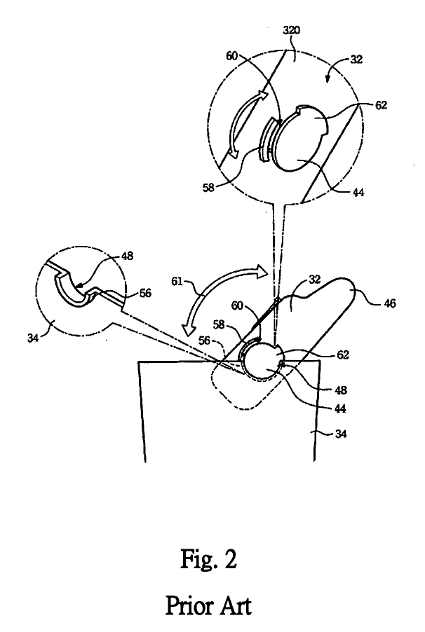

### DETAILED DESCRIPTION OF THE INVENTION (PREFERRED EMBODIMENTS)

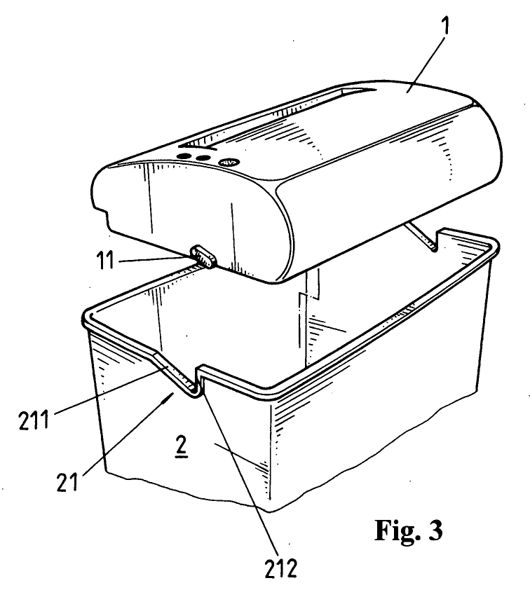

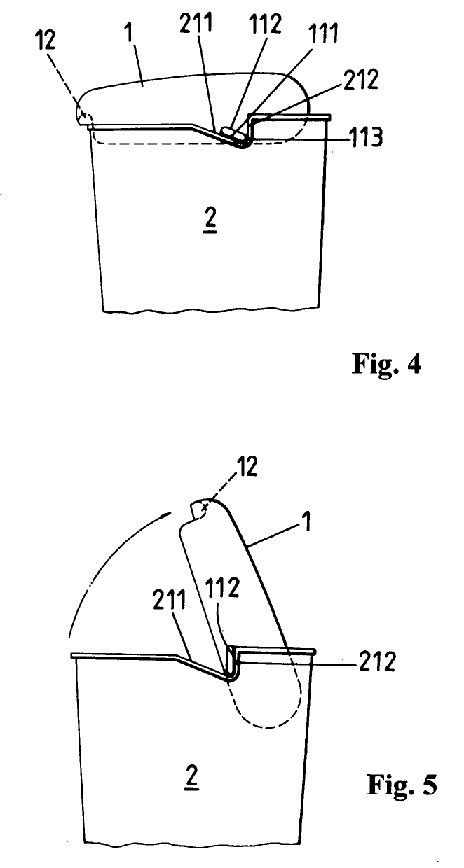

With reference to the drawings, FIG. 3 is an exploded, perspective view of the top-lifting paper shredder of this invention, and FIGS. 4 and 5 are schematic drawings illustrating the top-lifting paper shredder of this invention before and afar lifting, respectively.

In the drawings, a paper shredder 1 includes rectangular projections 11 each projecting outwards from an appropriate position of opposing sides of the paper shredder. V-shaped notches 21 are each formed to the wastebasket 2 and composing a lower slant 211 and a wall face 212. When the paper shredder 1 is placed above the wastebasket 2, a lower edge 11 of the rectangular projections projecting from the opposing sides of the paper shredder 1 abuts against a joint between the lower slant 211 and the wall face 212. Upon lifting up a grip 12 provided to a front end of the paper shredder 1, the rectangular projections 11 would flip upwards within the notches 21 of the wastebasket, causing an upper edge 112 of the rectangular projections to abut against the wall face 212 of the notches of the wastebasket to keep the paper shredder at an upright position and to allow the user's palm to press the shreds for increasing the capacity of the wastebasket.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A top-lifting paper shredder, including: rectangular projections each projecting outwards from an appropriate position of opposing sides of the paper shredder; notches formed to the wastebasket and composing a lower slant and a wall face at locations corresponding to the rectangular projections. When the paper shredder is placed above the wastebasket, the rectangular projections projecting from the opposing sides of the paper shredder abut against the notches of the wastebasket, whereby upon lifting up a grip provided to a front end of the paper shredder, the rectangular projections would flip upwards within the notches so as to keep the paper shredder at an upright position and to allow a user's palm to press the shreds for increasing the capacity of the wastebasket

2. The top-lifting paper shredder of claim 1, wherein the notches of the wastebasket each compose a lower slant and a wall face.

3. The top-lifting paper shredder of claim 1, wherein when the paper shredder is placed over the wastebasket, each of the rectangular projections projecting from the opposing sides of the paper shredder abuts against the lower slant of the respective notch of the wastebasket, and a front edge of the rectangular projections abuts against a respective joint of the lower slant and wall face.

4. The top-lifting paper shredder of claim 1, wherein the an upper edge of each of the rectangular projections projecting from the opposing sides of the paper shredder abuts against the respective wall face of the notch of the wastebasket upon lifting the paper shredder upwards to an upright position.
